(19) United States
(12) Patent Application Publication
(10) Pub. No.: US 2012/0131060 A1
(43) Pub. Date: May 24, 2012

(54) SYSTEMS AND METHODS PERFORMING SEMANTIC ANALYSIS TO FACILITATE AUDIO INFORMATION SEARCHES

(76) Inventor: Robert Heidasch, Speyer (DE)

(21) Appl. No.: 12/953,649

(22) Filed: Nov. 24, 2010

(51) Int. Cl. G06F 17/30

(52) U.S. Cl. 707/794; 707/E17.049

(57) ABSTRACT

According to some embodiments, audio information may be received at a speech recognition engine. The speech recognition engine may then automatically create: (i) a text transcript representing the audio information, and (ii) meta-data associated with the audio information, the meta-data including a term index. A semantic analysis may then be automatically performed for the audio information, and the semantic analysis may be based, for example, at least in part on a terminology repository and at least one of the text transcript or the meta-data. A result of the semantic analysis may be stored in a semantic index in relation to a record of the audio information.

### FIELD

Some embodiments relate to audio information. More specifically, some embodiments are associated with systems and methods wherein a semantic analysis is performed to facilitate audio information searches.

### BACKGROUND

A large amount of data is available in the form of audio information. For example, television and radio news reports, presentations by stock analysts, and shareholder meetings or teleconferences may be available in the form of audio streams or stored audio files. In some cases, a user might access a search platform in an attempt to find a particular audio document or audio documents that may be relevant to his or her interests. For example, a user might submit a search query, including a search phrase (e.g., “Company, Inc. sales forecast”), to a search platform and receive one or more audio documents from the search platform as a search result. He or she may then listen to the audio documents and hear the relevant information.

Note that it may be important to provide search results to a user in a relatively short amount of time. That is, taking several minutes to locate relevant audio documents may be unacceptable to many users (e.g., who might need to make quick decisions based on the data in the audio documents). Moreover, locating relevant audio documents based on a search phrase can be a difficult task. For example, a user might enter the name of the Chief Financial Officer (“CFO”) of Company, Inc. (e.g., “Amanda Jones”). A particular audio document, however, might only refer to her by her title (e.g., “The CFO of Company, Inc. announced today . . . ”). This may be especially true because spoken words tend to be less formal as compared to written words. Moreover, different people might have held that title at various times in the past. Such factors can make it difficult to locate all relevant documents in a timely manner.

Accordingly, systems and methods to automatically and efficiently facilitate audio information searches may be provided in association with some embodiments described herein.

### BRIEF DESCRIPTION OF THE DRAWINGS

FIG. 1 is block diagram of a system associated with audio information searches.

FIG. 2 is an illustration of audio information in accordance with some embodiments.

FIG. 3 is a flow diagram of a process in accordance with some embodiments.

FIG. 4 is a block diagram of an audio information searching system according to some embodiments.

FIG. 5 is a flow diagram of a process in accordance with some embodiments.

FIG. 6 is a more detailed block diagram of an audio information searching system according to some embodiments.

FIG. 7 is a block diagram of a system in accordance with some embodiments.

FIG. 8 is a tabular representation of a portion of an intermediate audio database according to some embodiments.

FIG. 9 is a tabular representation of a portion of a searchable semantic audio database according to some embodiments.

### DETAILED DESCRIPTION

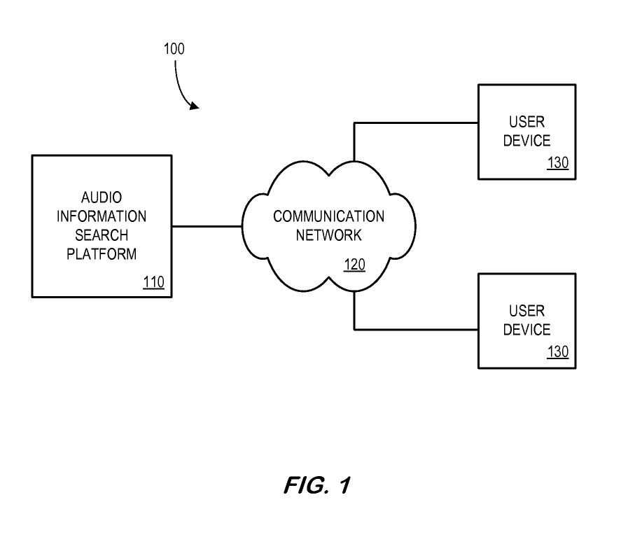

A large amount of data is available in the form of audio information. For example, television and radio news reports, presentations by stock analysts, and shareholder meetings or teleconferences may be available in the form of audio streams or stored audio files. In some cases, a user might access a search platform in an attempt to find a particular audio document or audio documents that may be relevant to his or her interests. For example, FIG. 1 illustrates a system 100 including an audio search platform 110. The audio search platform 110 might receive, via a communication network 120, audio search queries from one or more remote user devices 130.

The audio information search platform 110 and/or user devices 130 may comprise any devices capable of performing the various functions described herein. For example, a user device 130 might be a Personal Computer (PC), a laptop computer, a Personal Digital Assistant (PDA), a wired or wireless telephone, or any other appropriate storage and/or communication device. The audio information search platform 110 may be, for example, a Web server adapted to exchange information with the user devices 130 and/or other devices. As used herein, devices (e.g., the audio information search platform 110 and the user devices 130) may communicate, for example, via the communication network 120, such as an Internet Protocol (IP) network (e.g., the Internet). Note that the communication network 120 can also include a number of different networks, such as an intranet, a Local Area Network (LAN), a Metropolitan Area Network (MAN), a Wide Area Network (WAN), a proprietary network, a Public Switched Telephone Network (PSTN), and/or a wireless network.

Although a single audio information search platform 110 is shown in FIG. 1, any number of these devices may be included in the system 100. Similarly, any number of user devices 130, or any other devices described herein, may be included in the system 100 according to embodiments of the present invention.

A user device 130 might transmit a search query, including a search phrase (e.g., “Company, Inc. sales forecast”), to audio information search platform 110 and receive one or more audio documents (or links to the audio documents) from the audio information search platform 110 as a search result. He or she may then listen to the audio documents and hear the relevant information. Note that it may be important for the audio information search platform 110 to provide search results to the remote user devices 130 in a relatively short amount of time. That is, taking several minutes to locate relevant audio documents may be unacceptable to many users (e.g., who might be stock traders who need to make quick decisions based on the data in the audio documents).

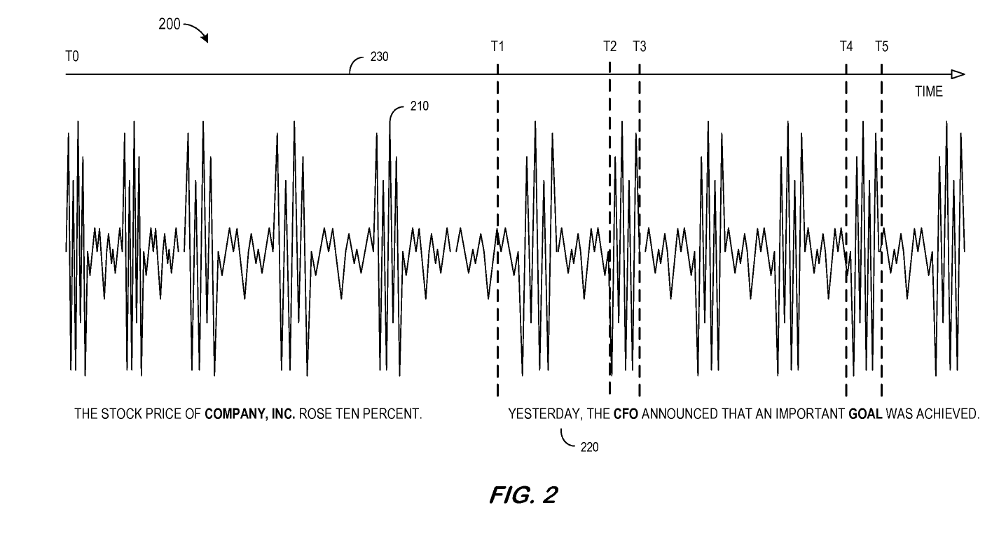

As used herein, “audio information” may refer to any time of audio data, including digital and analog versions of audio documents or files. For example, FIG. 2 is an illustration 200 of audio information including a sound wave 210 that might be stored or streamed in a digital and/or compressed format (e.g., as a .wav or .mp3 file). Note that the sound wave 210 might be received or stored in connection with an associated video. As other examples, the sound wave 210 could be associated with a podcast, an audio on demand service, a radio broadcast, or an audio book. A transcription 220 of the sound wave 210 is also provided. Note that locating relevant audio documents based on a search phrase can be a difficult task. For example, the transcription 220 refers to the “CFO” of Company Inc. without specifically mentioning his or her name. Further note that different people might have been the CFO at various times in the past. As another example, the word “goal” might have different meanings depending on the context of the audio document. Consider for example, the appearance of the word “goal” in a stock roundup newscast as compared to a sports report discussing the World Cup. Such factors can make it difficult to locate all relevant documents in a timely manner.

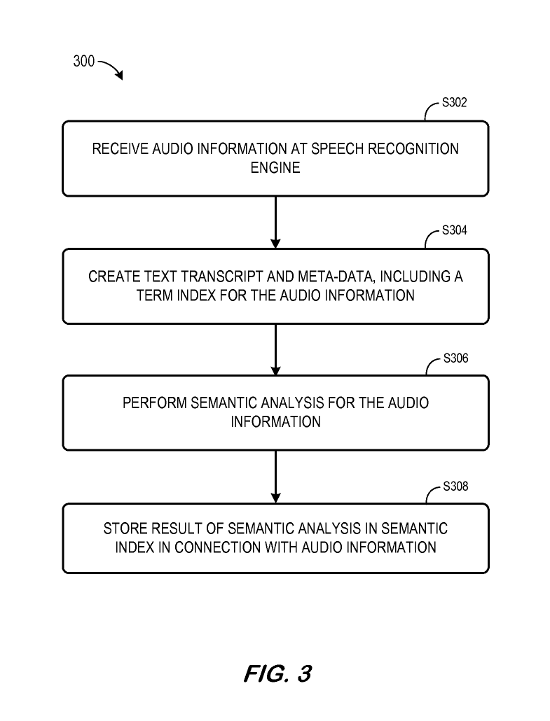

Some embodiments described herein provide systems and methods to automatically and efficiently facilitate audio information searches. For example, FIG. 3 is a flow diagram of a process 300 in accordance with some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At S302, audio information may be received at a speech recognition engine. At S304, the speech recognition engine may automatically create: (i) a text transcript representing the audio information, and (ii) meta-data associated with the audio information. The meta-data might include, for example, an author associated with the audio information, a date or time associated with the audio information, and/or a description of the contents of the audio information.

According to some embodiments, the meta-data includes a term index associated with the audio information. Consider, for example, the transcription 220 of FIG. 2. In this case, the terms “Company, Inc.,” “CFO,” and “goal” might be determined to be of potential interest to users (as indicated by bold lettering int he transcription 220). According to some embodiments, time offset information might be automatically stored in association with the audio information. For example, a term offset might be stored for each term in the term index to indicate when the term appears in the audio document. In the timeline 230 of FIG. 2, the term “CFO” might be tagged as appearing between times T2 and T3 while the term “goal” is tagged as appearing between times T4 and T5. According to some embodiments, the time offset represents a sentence offset pointing to where a sentence containing a term begins. For example, the term “Company, Inc.” might be tagged as appearing in a sentence that begins at time T0 (e.g., the start of the audio document). According to some embodiments, the speech recognition engine creates the text transcript and meta-data in substantially real time. In this way, for example, at least some access to the audio information might be made available to a search platform almost immediately. Note that according to some embodiments, meta-data may be provided at various levels of granularity (e.g., a word level, sentence level, or document level).

At S306, a semantic analysis may be automatically performed for the audio information, the semantic analysis being based at least in part on a terminology repository and at least one of the text transcript or the meta-data. The semantic analysis might be, for example, associated with a terminology registry. The terminology registry might, for example, provide synonyms and related words or subjects for entries in the term index (e.g., if “IMF” was in the term index, then “International Monetary Fund” might be determined to be semantically relevant). According to some embodiments, the semantic analysis is associated with a context specific analysis (e.g., based on the context of the audio information) and/or or a domain specific terminology analysis (e.g., medical or legal terms). Note that the semantic analysis might not need to be performed in substantially real time. In this way, substantial semantic enhancements might be made (and will be readily available when users later search for the audio information).

At S308, a result of the semantic analysis may be stored in a semantic index in relation to a record of the audio information. After the result of the semantic analysis is stored in the semantic index, the information may be used to improve subsequent audio search results for users. For example, a search query, including at least one search term, might be received from a remote user via a web based search platform. A search result associated with the audio information may then be returned to the user based on the search term and the semantic index. According to some embodiments, time offset information associated with the audio information may have been created and stored, for example, in the term index. In this case, a search platform might transmit only the relevant portion of the audio information to the user based at least in part on the search result and the time offset information.

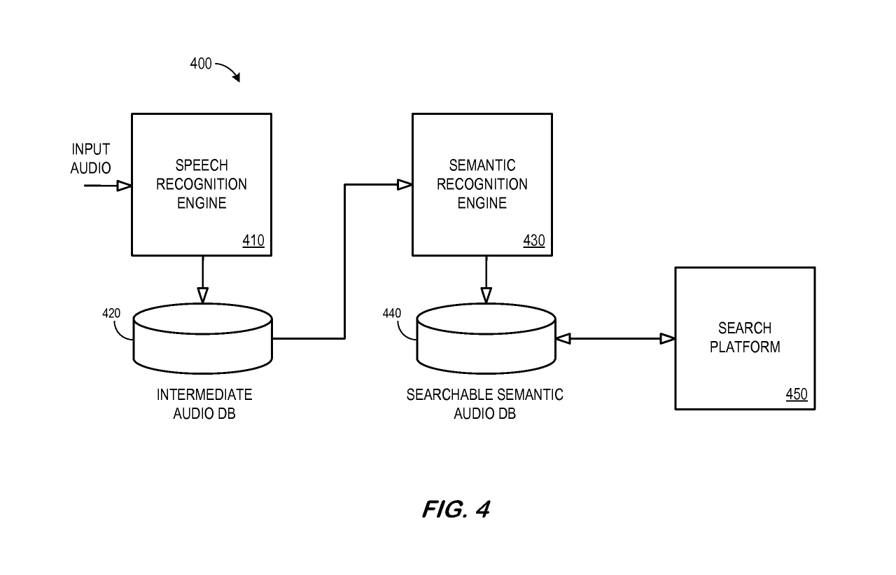

FIG. 4 is a block diagram of an audio information searching system 400 according to some embodiments. According to this embodiment, audio files and/or streams may be received at a speech recognition engine 410. The speech recognition engine 410 may automatically create: (i) a text transcript representing the audio information and/or (ii) meta-data associated with the audio information. The meta-data might include, for example, an author associated with the audio information, a date or time associated with the audio information, and/or a description of the contents of the audio information. According to some embodiments, the meta-data includes a term index associated with the audio information and/or time offset information. The text transcript, meta-data, term index, and/or time offset information may be stored into an intermediate audio database 420. According to some embodiments, a link, pointer, or identifier associated with the received audio file or stream is also stored in the intermediate audio database 420. Note that according to some embodiments, the generation of a text transcript and/or associated data may be performed manually (e.g., by a human in connection with a closed captioning service). Moreover, in some cases the text transcript might be received independently from the audio information (e.g., when the audio information is associated with a prepared speech, the text of which has been released in advance).

A semantic recognition engine 430 may then access information in the intermediate audio database 420 to perform a semantic analysis. The semantic recognition engine 430 may perform the semantic analysis, according to some embodiments, based at least in part on a terminology repository and at least one of the text transcript or the meta-data. The semantic analysis might be, for example, associated with a terminology registry, a context specific analysis, and/or or a domain specific terminology analysis. The semantic recognition engine 430 may then store a result of the semantic analysis in a searchable semantic audio database 440 in connection with the audio information. After the result of the semantic analysis is stored in the searchable semantic audio database 440, the information may be used to improve subsequent audio search results performed by a search platform 450.

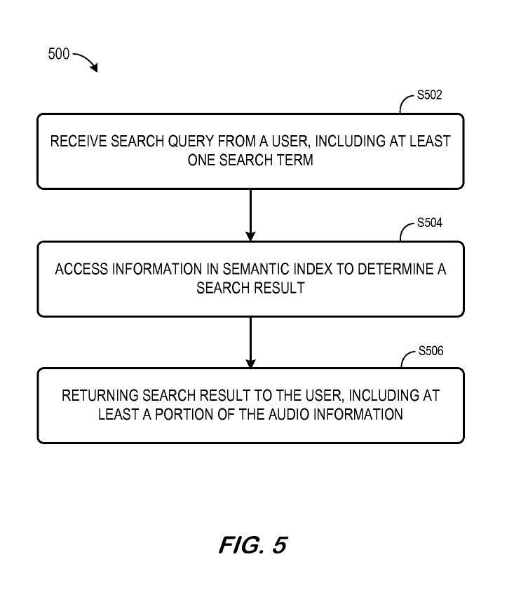

For example, FIG. 5 is a flow diagram of a process 500 that may be associated with the search platform 450 in accordance with some embodiments. At S502, a search query including at least one search term may be received from a user. The search query might, for example, include the phrase “CFO of Company, Inc.” The search platform 450 may then automatically access information in a semantic index (e.g., the searchable semantic audio database 440) at S504 to determine a search result based at least in part on the search term. At S506, the search result may then be returned to the user, including at least a portion of the audio information. According to this example, the search result might include an audio clip referencing Amanda Jones (without mentioning her title) because the semantic recognition engine 430 realized that she was the CFO of Company, Inc.

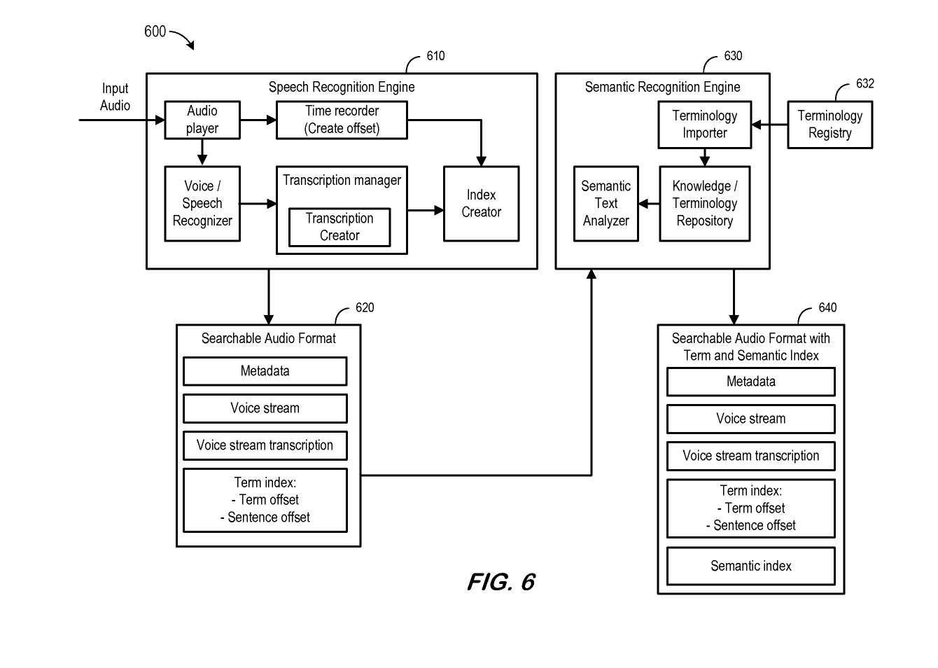

FIG. 6 is a more detailed block diagram of an audio information searching system 600 according to some embodiments. According to this embodiment, audio files and/or streams may be received at an audio player of a speech recognition engine 610. Note that increasing amounts of business relevant information may be found in audio files. For example, a current market analysis and trends may be provided as information broadcast by radio or television stations such as Bloomberg News or CNN. The fast access to this type of information may be important to decision makers and, as a result, a search functionality—especially semantic related search function (e.g., associated with an integration of semantic search engines) may need to be executed in an efficient manner.

Note that from a technical perspective, audio data may be received and/or stored in different audio formats (e.g., uncompressed or compressed, using coding and/or codepages) but the information is not directly searchable for a search engine. To search for information/terminology within audio documents, an introduction of a new/extended audio document format may be provided along with the appropriate technology to create of required information.

The audio player of the speech recognition engine 610 may output information, for example, to a time recorder that creates offset values. The audio player may also output information to and a voice speech recognizer that converts sound to text. A transcription manager and creator may use the text to generate a transcript to be stored in a searchable audio format file 620. The offset values and transcript may be combined by an index creator and also be stored in the searchable audio formal file 620.

As a result, the searchable audio format file 620 may include a document header including meta-data (e.g., an author/creator, a creation data and time, and a short description of the document). The searchable audio format file 620 may also include a document body containing the original voice stream data, a transcription (generated text from the voice stream), a term Index (an index of used terms) and/or an offset for each term (e.g., in milliseconds) to allow a localization of the term in audio document.

The searchable audio format file 620 may bet imported by a search engine that uses it to create internal index. As a result, the search engine may find and/or provide direct access to content of the “original” audio document by opening the audio document in an audio player and playing the found sentence (using offset information—go to term or sentence). Additionally, the transcription of the audio document might be presented to the end-user. Note that the speech recognition engine 610 may operate in substantially real time. As a result, an online audio stream (e.g., an internet radio program) may be indexed in substantially real time and then imported into search engines. Note that “substantially real time” might refer to only a small delay between the audio information and indexing introduced by the speech recognition engine 610. In connection with pre-recorded audio information, note that the information may be analyzed and or indexed faster than “real time” (e.g., a recorded twenty minute lecture might be converted into a transcript and/or indexed within ten minutes).

Note that a transcript generated by the speech recognition engine 610 might comprise a phonetic representation of the audio information. For example, the transcript might include a reference to the sound “hiil” which could be associated with the word “heal” or the word “heel.”

A semantic recognition engine 630 may access information in the searchable audio format file 620 to perform a semantic analysis. The semantic recognition engine 630 may perform the semantic analysis, according to some embodiments, based at least in part on information in a knowledge/terminology repository, including information from an external terminology registry 632 imported by a terminology importer of the semantic recognition engine 630.

According to some embodiments, the transcription and index are used as inputs for the semantic recognition engine 630 which may include a recognizer and/or analyzer that uses terminology definitions (e.g., terms defined and grouped in knowledge domains) to recognize semantically relevant information. For example, terminology may be defined in a knowledge package as being especially important from the semantic perspective. The terminology might be modeled as a network of term and its relation, and may be created by a modeling tool which exposes a definition via a terminology registry.

The semantic information may be used by the semantic text analyzer to create a semantic index (semantically extended term index) that, for example, allows a building of business relevant stemming information. This information may be used by an advanced search engine to create and/or provide semantic-related search dispatching functionality. For example, the search engine might support semantic analysis to analyze a search request and use this information to dispatch a searching request to appropriate searching modules (sub-search engines) that may be specialized in searching in particular context.

The semantic recognizer and/or analyzer might not comprise a “real-time” engine. As a result, the extensive and time consuming semantic analysis and/or processes can be done after the “original” document transcription and term index are made available.

The semantic recognition engine 630 may then store a result of the semantic analysis in a searchable audio format within a term and/or semantic index in connection with the audio information. After the result of the semantic analysis is stored in the searchable audio format within the term and/or semantic index, the information may be used to improve subsequent audio search results performed by a search platform.

Thus, embodiments may provide an extended audio format which allows the storing of “original” audio content and additional information that can be used by search engines and to find audio documents. The additional information may contain transcription and term/semantic indexes that can be imported by a search engine to enrich the content indexes improve searches for content in audio documents. Additionally, the index may contain the term and sentence relevant localization data (offset to term and sentence where the term is used). The localization data can be used by a media player (e.g., a device and/or software application that can open and play the audio document) to localize the terms and sentences directly in audio documents and play the relevant sentences to a user.

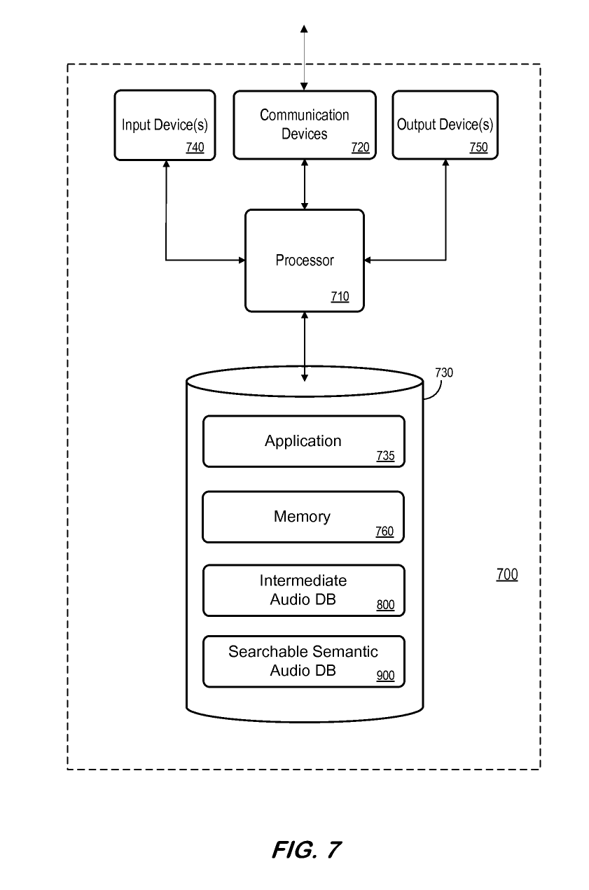

The processes described herein with respect to FIGS. 3 and 5 may be executed by any number of different hardware systems and arrangements. For example, FIG. 7 is a block diagram of a system 700, such as a system 700 associated with a speech recognition engine, a semantic recognition engine, and/or a search platform in accordance with some embodiments. The system 700 may include a processor 710, such as one or more Central Processing Units (“CPUs”), coupled to communication devices 720 configured to communicate with remote devices (not shown in FIG. 7). The communication devices 720 may be used, for example, to exchange search queries and results with remote devices. The processor 710 is also in communication with an input device 740. The input device 740 may comprise, for example, a keyboard, computer mouse, and/or a computer media reader. Such an input device 740 may be used, for example, to receive search requests and/or semantic information about audio documents. The processor 710 is also in communication with an output device 750. The output device 750 may comprise, for example, a display screen or printer. Such an output device 750 may be used, for example, to provide search results or information about audio documents to a user.

The processor 710 is also in communication with a storage device 730. The storage device 730 may comprise any appropriate information storage device, including combinations of magnetic storage devices (e.g., hard disk drives), optical storage devices, and/or semiconductor memory 760. The storage devices may have different access patterns, such as Random Access Memory (RAM) devices, Read Only Memory (ROM) devices and combined RAM/ROM devices.

As used herein, information may be “received” by or “transmitted” to, for example: (i) the system 700 from other devices; or (ii) a software application or module within the system 700 from another software application, module, or any other source.

The storage device 730 stores an application 735 for controlling the processor 710. The processor 710 performs instructions of the application 735, and thereby operates in accordance any embodiments of the present invention described herein. For example, the processor 710 may receive audio information and automatically create (i) a text transcript representing the audio information, and (ii) meta-data associated with the audio information, the meta-data including a term index. The processor 710 may also perform a semantic analysis for the audio information, the semantic analysis might, for example, be based on a terminology repository and at least one of the text transcript or the meta-data. A result of the semantic analysis might then be stored by the processor 710 in a semantic index in connection with the audio information.

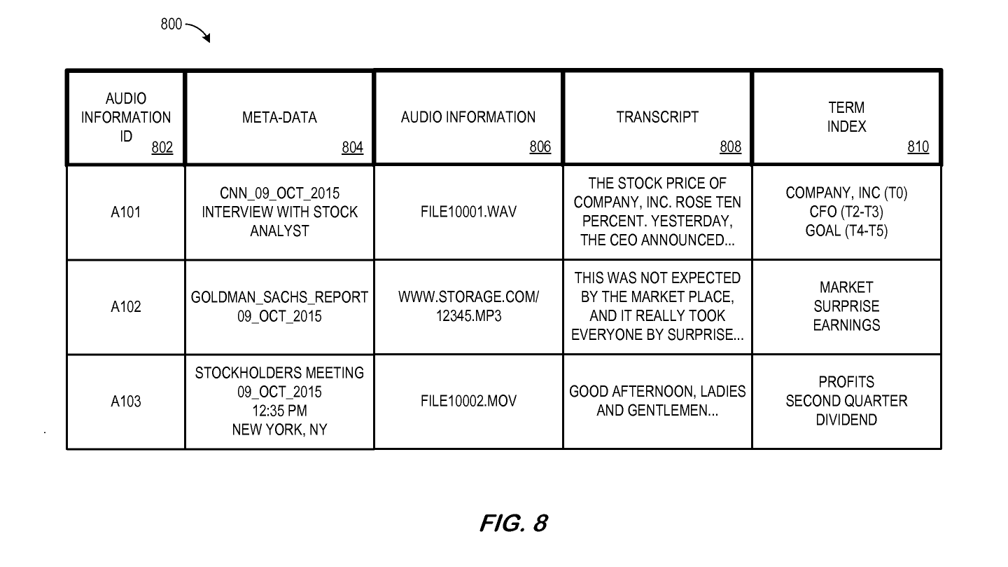

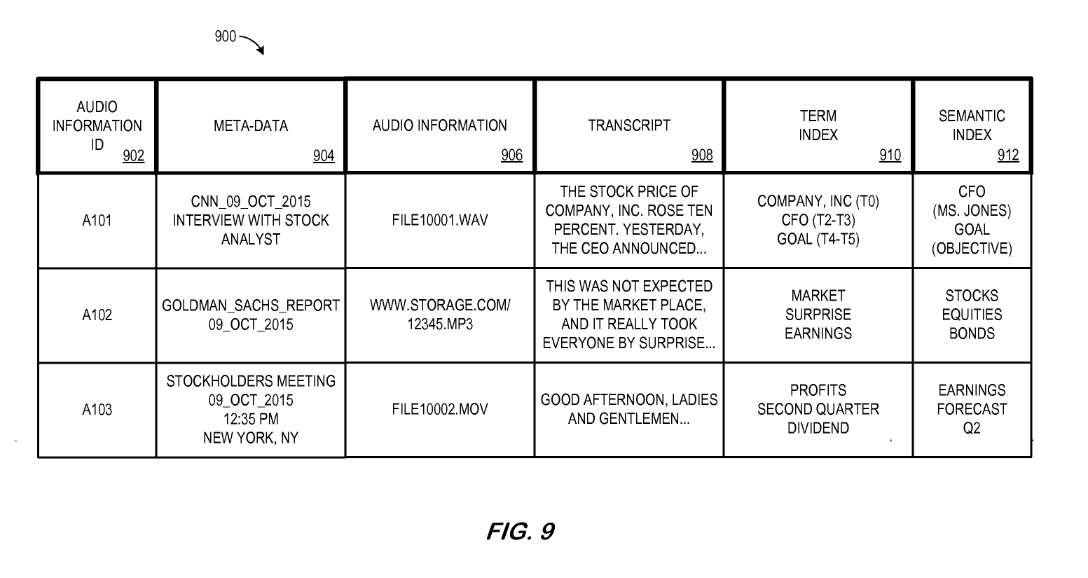

As shown in FIG. 7, the storage device 730 also stores: an intermediate audio database 800 (described with respect to FIG. 8) and a searchable audio database 900 (described with respect to FIG. 9). Examples of databases that may be used in connection with the system 700 will now be described in detail with respect to FIGS. 8 and 9. The illustrations and accompanying descriptions of the databases presented herein are exemplary, and any number of other database arrangements could be employed besides those suggested by the figures.

Referring to FIG. 8, a table represents the intermediate audio database 800 that may be stored at the system 700 according to an embodiment of the present invention. The table includes entries identifying audio documents. The table also defines fields 802, 804, 806, 808, 810 for each of the entries. The fields specify: an audio information identifier 802, meta-data 804, audio information 806, a transcript 808, and a term index 810. The information in the intermediate audio database 800 may be created and updated, for example, by a speech recognition engine.

The audio information identifier 802 may be an alphanumeric code associated with a particular audio document being processed. The meta-data 804 may include, for example, an author and date associated with the audio document along with a brief description of the contents of the document. The audio information 806 might comprise a copy of the audio document itself or a pointer indicating where the audio document is stored. The transcript 808 may comprise an automatically generated text file representing what is said within the audio document. The term index 810 may list potentially important words in the transcript 808 and where those words are spoken in the audio information 806. For example, the work “goal” can be found at time T4 through T5 as illustrated by the term index 810 in FIG. 8 and the example provided in FIG. 2.

The information in the intermediate audio database 800 may then be semantically processed and/or enhanced. For example, referring to FIG. 9, a table represents a searchable semantic audio database 900 that may be stored at the system 700 according to an embodiment of the present invention. In this example, the information from the intermediate audio database 800 is duplicated, but not that in other embodiments the information might not actually need to be duplicated in the searchable semantic audio database 900. As in FIG. 8, the table includes entries identifying audio documents. The table also defines fields 902, 904, 906, 908, 910, 912 for each of the entries. The fields specify: an audio information identifier 902, meta-data 904, audio information 906, a transcript 908, a term index 910, and a semantic index 912. The information in the searchable semantic audio database 900 may be created and updated, for example, by a semantic recognition engine.

The audio information identifier 902 may be an alphanumeric code associated with a particular audio document being processed (and may be based on or identical to the audio information identifier 802 described in connection with the intermediate audio database 800). The meta-data 904 may include, for example, an author and date associated with the audio document along with a brief description of the contents of the document. The audio information 906 might comprise a copy of the audio document itself or a pointer indicating where the audio document is stored. The transcript 908 may comprise an automatically generated text file representing what is said within the audio document. The term index 910 may list potentially important words in the transcript 908 and where those words are spoken in the audio information 906. For example, the work “goal” can be found at time T4 through T5 as illustrated by the term index 910 in FIG. 9 and the example provided in FIG. 2.

The semantic index 912 may include supplemental information that a semantic recognition engine has determined might be relevant in connection with user searches. For example, because both “Company, Inc.” and “CFO” were included in the term index 910, the semantic recognition engine has placed the actual name of the CFO of Company, Inc. (“Ms. Jones”) in the semantic index 912. Thus, when a user subsequently submits an audio search request that includes the term “Ms. Jones,” the audio document associated with the audio document identifier 902 “A101” may be efficiently located.

According to some embodiments, the intermediate audio database 800 and/or searchable semantic audio database 900 may contain additional information. For example, the term index 810 and/or term index 910 might include additional information about the location of the words within an audio file (e.g., an audio steam). For example, information about word and/or phrase locations may allow for fast navigation and/or to an ability to start playing a found sentence in appropriate audio player.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, not that any number of other configurations may be provided in accordance with embodiments of the present invention (e.g., some of the information associated with the data files described herein may be combined or stored in external systems). Moreover, although examples of specific types of semantic enhancements have been described, embodiments of the present invention could be used with other types of semantic enhancements and enrichments.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method implemented by a computing system in response to execution of program code by a processor of the computing system, the method comprising:
receiving audio information at a speech recognition engine;
automatically creating by the speech recognition engine: (i) a text transcript representing the audio information, and (ii) meta-data associated with the audio information, the meta-data including a term index;
automatically performing a semantic analysis for the audio information, the semantic analysis being based at least in part on a terminology repository and at least one of the text transcript or the meta-data; and
storing a result of the semantic analysis in a semantic index in relation to a record of the audio information.

2. The method of claim 1, further comprising:
receiving, from a remote user, a search query including at least one search term; and
returning, to the user, a search result associated with the audio information based on the search term and the semantic index.

3. The method of claim 2, further comprising:
automatically storing time offset information associated with the audio information; and
transmitting a portion of the audio information to the user based at least in part on the search result and the time offset information.

4. The method of claim 3, wherein the time offset represents at least one of: (i) a term offset, or (ii) a sentence offset.

5. The method of claim 1, wherein the semantic analysis is associated with at least one of: (i) terminology registry, (ii) a context specific analysis, or (iii) a domain specific terminology analysis.

6. The method of claim 1, wherein the speech recognition engine creates the text transcript and meta-data in substantially real time.

7. The method of claim 6, wherein the semantic analysis is not performed in substantially real time.

8. The method of claim 1, wherein the audio information is associated with a video stream.

9. The method of claim 1, wherein the meta-data includes at least one of:
(i) an author associated with the audio information, (ii) a date or time associated with the audio information, or (iii) a description of the contents of the audio information.

10. A non-transitory, computer-readable medium storing program code executable by a computer to perform a method, said method comprising:
receiving, from a user, a search query including at least one search term;
automatically accessing information in a semantic index to determine a search result based at least in part on the search term, wherein the semantic index is to store results of a semantic analysis in connection with audio information; and
returning, to the user, the search result including at least a portion of the audio information.

11. The medium of claim 10, wherein the method further comprises:
receiving the audio information at a speech recognition engine;
automatically creating by the speech recognition engine: (i) a text transcript representing the audio information, and (ii) meta-data associated with the audio information, the meta-data including a term index;
automatically performing the semantic analysis for the audio information, the semantic analysis being based at least in part on a terminology repository and at least one of the text transcript or the meta-data; and
storing the result of the semantic analysis in the semantic index in connection with the audio information.

12. The medium of claim 11, wherein the method further comprises:
automatically storing time offset information associated with the audio information; and
transmitting a portion of the audio information to the user based at least in part on the search result and the time offset information, wherein the time offset represents at least one of: (i) a term offset, or (ii) a sentence offset.

13. The medium of claim 11, wherein the semantic analysis is associated with at least one of: (i) terminology registry, (ii) a context specific analysis, or (iii) a domain specific terminology analysis.

14. The medium of claim 11, wherein the speech recognition engine creates the text transcript and meta-data in substantially real time and the semantic analysis is not performed in substantially real time.

15. The medium of claim 10, wherein the audio information is associated with a video stream.

16. A system, comprising:
a speech recognition engine to receive audio information and automatically create: (i) a text transcript representing the audio information, and (ii) meta-data associated with the audio information, the meta-data including a term index;
an intermediate audio database to store the text transcript and meta-data;
a semantic recognition engine to perform a semantic analysis for the audio information, the semantic analysis being based at least in part on a terminology repository and at least one of the text transcript or the meta-data; and
a searchable semantic audio database including a semantic index to store a result of the semantic analysis in connection with the audio information.

17. The system of claim 16, further comprising:
a search platform to (i) receive, from a remote user, a search query including at least one search term; and (ii) return, to the user, a search result associated with the audio information based on the search term and the semantic index.

18. The system of claim 16, wherein the speech recognition engine further stores time offsets in a term index of the intermediate audio database, wherein a time offset represents at least one of: (i) a term offset, or (ii) a sentence offset.

19. The system of claim 18, wherein the searchable semantic audio database includes, in addition to the semantic index: (i) the metadata, (ii) the transcript, (iii) the audio information, and (iv) the term index.

20. The system of claim 16, wherein the semantic recognition engine comprises:
a semantic text analyzer to access to receive information from the term index of the intermediate audio database; and
a knowledge/terminology repository coupled to the semantic text analyzer.
